(19) United States
(12) Patent Application Publication
(10) Pub. No.: US 2006/0072281 A1
(43) Pub. Date: Apr. 6, 2006

(54) Methods of forming a layer utilizing a liquid-phase lanthanum precursor and methods of manufacturing a capacitor using the same

(75) Inventors: Gab-Jin Nam, Seoul (KR); Young-Geun Park, Gyeonggi-do (KR); Young-Sun Kim, Gyeonggi-do (KR); Han-Mei Choi, Seoul (KR); Seung-Hwan Lee, Seoul (KR); Ki-Yeon Park, Gyeonggi-do (KR); Cha-Young You, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/196,943

(22) Filed: Aug. 4, 2005

(30) Foreign Application Priority Data
Aug. 5, 2004 (KR) 10-2004-0061646

(51) Int. Cl. H01G 4/06

(52) U.S. Cl. 361/311

(57) ABSTRACT

The present invention can provide methods of forming a layer including lanthanum by utilizing a lanthanum precursor existing in a liquid phase at a room temperature. The present invention can further provide methods of forming layers including lanthanum on objects and methods of manufacturing a capacitor.

### CROSS-REFERENCE TO RELATED APPLICATION

This application claims priority to Korean Patent Application No. 2004-61646, filed on Aug. 5, 2004, the disclosure of which is incorporated herein by reference in its entirety as if set forth fully herein.

### FIELD OF THE INVENTION

The present invention relates to methods of forming a layer and methods of manufacturing a capacitor using the same. More particularly, the present invention relates to methods of forming a layer including lanthanum, and methods of manufacturing a capacitor including the layer formed thereby.

### BACKGROUND OF THE INVENTION

A semiconductor device having a high integration degree and a rapid response speed may be in demand for the development of information processing devices. Accordingly, methods of manufacturing semiconductor devices have been developed in an attempt to improve integration degree, reliability and response speed of the semiconductor device.

As the size of the design rule of a semiconductor memory device has been steadily decreasing, the area of the unit memory cell of the semiconductor memory device has been reduced. When an effective area of a capacitor is reduced, the cell capacitance may be decreased. When the cell capacitance decreases, the data readability of a memory cell may deteriorate, the generation rate of soft errors may increase, and thus, the low-voltage operation of a semiconductor memory device may be more difficult. Therefore, various methods of manufacturing a capacitor having an enhanced cell capacitance and/or reduced cell dimensions have been proposed.

In order to obtain a capacitor having an enhanced cell capacitance within limited cell dimensions, the effective area of the capacitor may be enhanced by forming a lower electrode having a cylindrical or pin shape, the thickness of a dielectric layer may be reduced, and a dielectric constant of the dielectric layer may be enhanced.

To ensure sufficient storage capacitance of the semiconductor memory device, the capacitor may possess a three-dimensional structure such as a box, a fin, a crown, a cylinder and the like. Further, the capacitor may include a lower electrode having a hemispherical grain (HSG). As the design rule of the semiconductor memory device decreases in size, the capacitor may have a larger aspect ratio that is the ratio between the height of the capacitor and the width of the capacitor, because the capacitor having a sufficient capacitance may be formed in a limited unit area of the semiconductor memory device. However, when the capacitor has a large aspect ratio, the manufacturing process of the capacitor may be more complex.

In order to enhance the capacitance of a capacitor, an equivalent oxide thickness (EOT) of a dielectric layer such as a silicon nitride layer/silicon oxide layer may be reduced. The limit of the equivalent oxide thickness of the silicon nitride layer/silicon oxide layer may be about 40 Å. When the equivalent oxide thickness of the silicon nitride layer and the silicon oxide layer is less than about 40 Å, the generation rate of leakage current from the silicon nitride layer/silicon oxide layer may rapidly increase.

An increase of the effective area of a capacitor or a decrease of the equivalent oxide thickness of a dielectric layer, however, may have a physical or economical limitation with respect to enhancing the capacitance of a capacitor. As semiconductor devices have reduced cell dimensions, the increase of the effective area of a capacitor or the decrease of the equivalent oxide thickness of a dielectric layer may not ensure a greater capacitance and electrical stability simultaneously.

Recently, a high dielectric constant material, which can be employed as a dielectric layer of a capacitor, has been developed. A dielectric layer having a high dielectric constant material may be substituted for a conventional dielectric layer. The conventional dielectric layer may include a silicon oxide layer, a silicon nitride layer, a composite layer of a silicon oxide layer and a silicon nitride layer and the like. The dielectric layer having a high dielectric constant material may include a tantalum oxide layer, a hafnium oxide layer, a titanium oxide layer, an aluminum oxide layer, a lanthanum oxide layer and the like. In addition, a ferroelectric layer may be to form the dielectric layer. The ferroelectric layer may include lead zirconate titanate (PZT), lead lanthanum zirconate titanate (PLZT), barium strontium titanate (BST), strontium titanate (STO) and the like.

When applicability for semiconductor manufacturing processes is considered, a dielectric layer having the high dielectric constant material may be desirable rather than the ferroelectric layer because of advantages that may be associated with stability for an etching process, large scale manufacturing and device operation.

A lanthanum oxide layer is an example of a dielectric layer having a high dielectric constant material. Many lanthanum precursors exist in a solid-phase. However, such solid-phase precursors may be difficult to use in forming a layer using a chemical vapor deposition (CVD) process or an atomic layer deposition (ALD) process.

### SUMMARY OF THE INVENTION

Embodiments of the present invention provide methods of forming a layer having improved electrical characteristics by using a liquid-phase lanthanum precursor during the manufacturing process.

In particular, embodiments of the present invention provide methods of forming a layer including lanthanum by using a lanthanum precursor having a liquid-phase at room temperature. In some embodiments, the lanthanum precursor comprises tris(i-propylcyclopentadienyl)lanthanum (La(iPrCp)₃).

Further embodiments of the present invention provide methods of forming a layer on an object including vaporizing liquid-phase La(iPrCp)₃ into vapor-phase La(iPrCp)₃; introducing the vapor-phase La(iPrCp)₃ onto the object; and forming a lanthanum oxide layer on the object using the vapor-phase La(iPrCp)₃. In some embodiments, the lanthanum oxide layer is formed using an atomic layer deposition process or a chemical vapor deposition process.

Embodiments of the present invention provide methods of manufacturing a capacitor including forming a lower electrode on a substrate including lower structures; forming a lanthanum oxide layer on the lower electrode using La(iPrCp)₃ as a precursor; and forming an upper electrode on the lanthanum oxide layer.

### BRIEF DESCRIPTION OF THE DRAWINGS

FIGS. 1A through 1E present cross-sectional views illustrating methods of forming a layer in accordance with some embodiments of the present invention;

FIGS. 2 through 4 present enlarged cross-sectional views illustrating a precursor introducer of “I” in FIGS. 1A to 1E in accordance with some embodiments of the present invention;

FIGS. 5A and 5B present cross-sectional views illustrating methods of forming a layer in accordance with some embodiments of the present invention;

FIGS. 6A through 61 present cross-sectional views illustrating methods of manufacturing a capacitor in accordance with some embodiments of the present invention;

FIG. 7 presents a graph illustrating a dielectric constant of a lanthanum oxide layer in accordance with embodiments of the present invention as presented in Example 1;

FIG. 8 presented a graph illustrating a dielectric constant of a lanthanum oxide layer in accordance with embodiments of the present invention as presented in Example 2; and

FIG. 9 presents a graph illustrating leakage current characteristics of the dielectric layer in accordance with embodiments of the present invention as presented in Example 2.

### DETAILED DESCRIPTION OF EMBODIMENTS ACCORDING TO THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Also, as used herein, the term “and/or” includes any and all combinations of one or more of the associated listed items.

Unless otherwise defined, all terms (including technical and scientific terms) used herein have the same meaning as commonly understood by one of ordinary skill in the art to which this invention pertains. All publications, patent applications, patents, and other references mentioned herein are incorporated by reference in their entirety.

Moreover, it will be understood that steps comprising the methods provided herein can be performed independently or at least two steps can be combined. Additionally, steps comprising the methods provided herein, when performed independently or combined, can be performed at the same temperature and/or atmospheric pressure or at different temperatures and/or atmospheric pressures without departing from the teachings of the present invention.

It will be further understood that the terms “comprises,” “includes”, “including” and/or “comprising,” when used in this specification, specify the presence of stated features, steps, operations, elements, and/or components, but do not preclude the presence or addition of one or more other features, steps, operations, elements, components, and/or groups thereof.

In the drawings, the thickness of layers and regions may be exaggerated for clarity. It will be understood that when a layer is referred to as being “on” another layer or element, it can be directly on the other layer, or intervening layers may also be present. Alternatively, when an element is described as being “directly on” another element, no intervening elements are present between the elements. Additionally, like numbers refer to like elements throughout.

Embodiments of the present invention are further described herein with reference to cross-section illustrations that are schematic illustrations of idealized embodiments of the present invention. As such, variations from the shapes of the illustrations as a result, for example, of manufacturing techniques and/or tolerances, are to be expected. In particular, the regions illustrated in the figures are schematic in nature and their shapes are not intended to illustrate the precise shape of a region of a device and are not intended to limit the scope of the present invention.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As will be appreciated by one of skill in the art, the present invention may be embodied as compositions and devices including the compositions as well as methods of making and using such compositions and devices. Moreover, each embodiment described and illustrated herein includes its complementary conductivity type embodiment as well.

Examples of the lanthanum precursor of the present invention, which may be employed for forming a layer including lanthanum are shown below in Table 1.

TABLE 1

| | | Phase at |
|---|---|---|
| | Nomenclature | 25° C. |
| La(THD)₃ | Tris(2,2,6,6-tetramethyl-3,5- | White Powder |
| | heptanedionato)lanthanum | |
| La(NPMP)₃ | Tris(1-n-propoxy-2-methyl-2-propoxy) | White Powder |
| | lanthanum | |
| La(NPEB)₃ | Tris(2-ethyl-1-n-propoxy-2-butoxy) | White Powder |
| | lanthanum | |
| La(EDMDD)₃ | Tris(6-ethyl-2,2-dimethyl-3,5- | White Powder |
| | decanedionato)lanthanum | |
| La(iPrCp)₃ | Tris(i-propylcyclopentadienyl) | Viscous Pale- |
| | lanthanum | yellow Liquid |

When forming a layer in a semiconductor device using an atomic layer deposition process or a chemical vapor deposition process, the reactant introduced into the chamber may have a vapor phase. Referring to Table 1, La(THD)₃, La(NPMP)₃, La(NPEB)₃ and La(EDMDD)₃ exist in a solid phase at room temperature, whereas La(iPrCp)₃ exists in a liquid phase at room temperature. In order to employ the solid-phase precursor for use in the atomic layer deposition process or a chemical vapor deposition process, the solid-phase precursor may be vaporized or dissolved in an organic solvent.

A method of vaporizing the solid-phase precursor may require a significant amount of energy. Thus, vaporizing the solid-phase precursor may not be economically beneficial or recommended. Additionally, dissolving the solid-phase precursor in the organic solvent may generate carbon impurities in the resultant layer. The carbon impurities may cause deterioration of the semiconductor device. Therefore, the lanthanum precursor of the present invention may exist in a liquid phase.

In some embodiments of the present invention, the lanthanum precursor having a liquid phase may include La(iPrCp)₃. The chemical structure of the La(iPrCp)₃ is shown below.

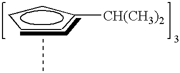

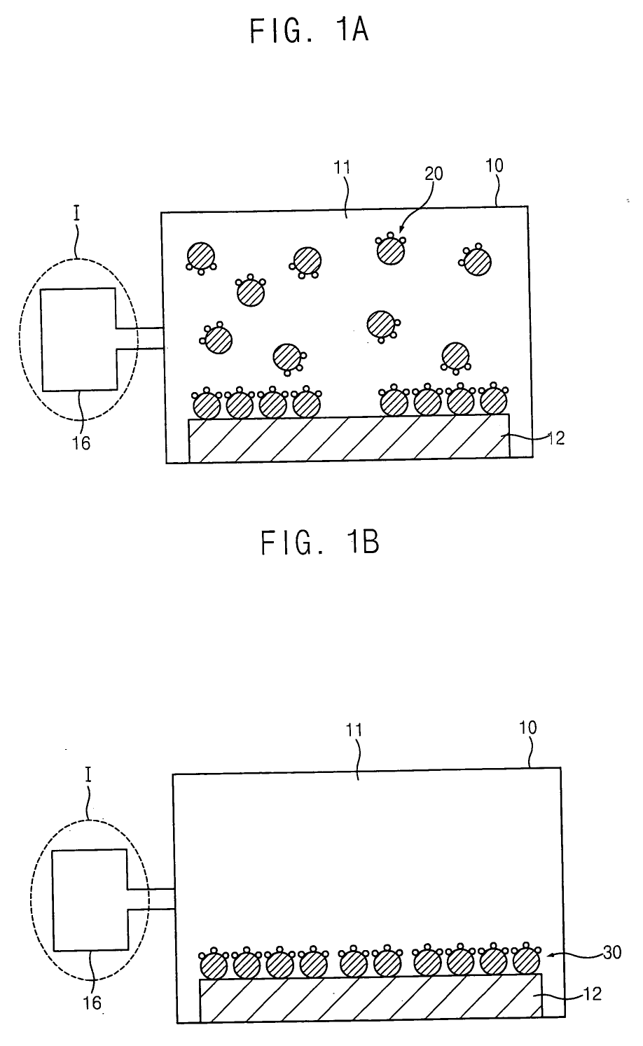

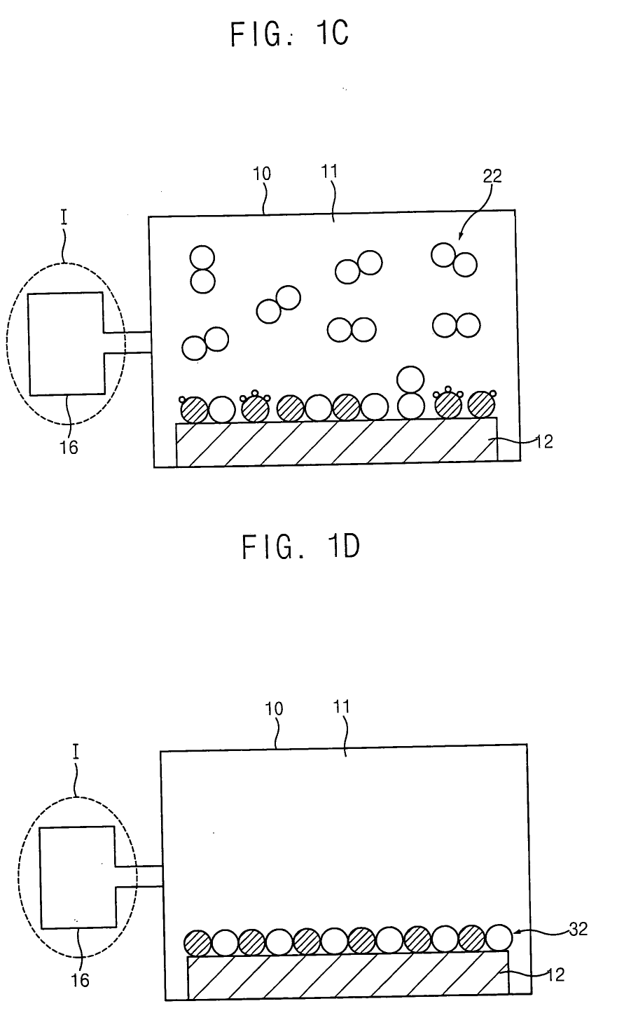

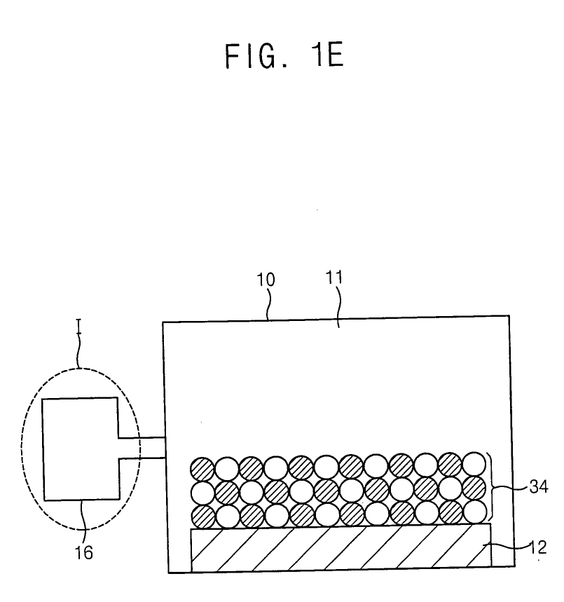

FIGS. 1A through 1E present cross-sectional views illustrating methods of forming a layer on an object in accordance with some embodiments of the present invention. Referring to FIG. 1A, a substrate 12 is loaded into a chamber 10, and then a vapor-phase lanthanum precursor 20 is introduced into a reaction space 11 of the chamber 10 (i.e., onto the substrate).

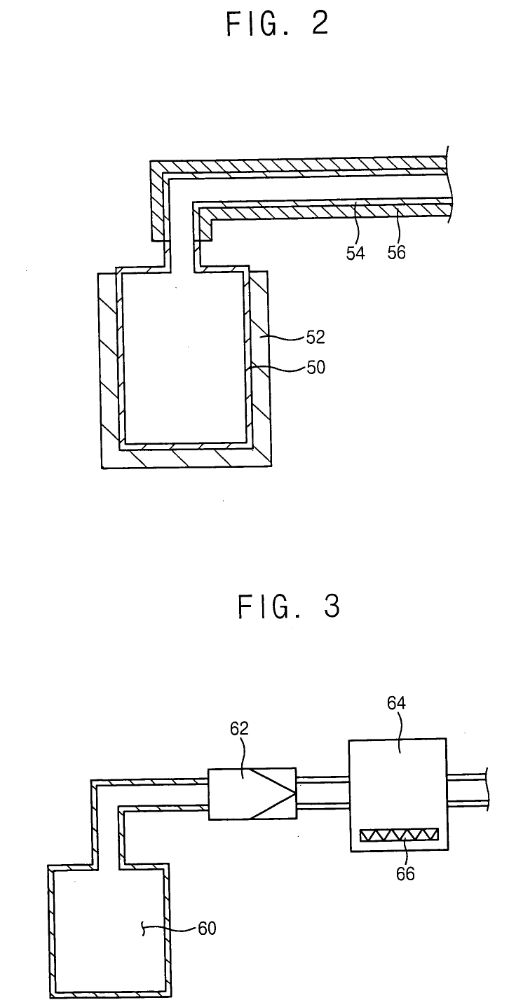

FIGS. 2 to 4 present cross-sectional views illustrating a precursor introducer 16 of “I” in FIGS. 1A to 1E. More specifically, a liquid-phase lanthanum precursor is vaporized into a vapor-phase lanthanum precursor 20 in the precursor introducer 16 such as a bubbler, an injector or an LDS type. A vapor-phase lanthanum precursor 20 is introduced into the reaction space 11 of the chamber 10. In some embodiments, the precursor introducer 16 having an LDS type may be employed because deterioration of the precursor may be prevented and a constant amount of the precursor may be provided to the chamber 10.

FIG. 2 presents a cross-sectional view illustrating a precursor introducer 16 having a bubbler type in accordance with some embodiments of the present invention. Referring to FIG. 2, a bubbler 50 of the precursor introducer 16 includes a liquid-phase precursor. The bubbler 50 is surrounded by a first heater 52, excluding a top portion of the bubbler 50. When the first heater 52 raises the temperature of the bubbler 50 to a predetermined value, a portion of the liquid-phase precursor may be vaporized and the pressure of the bubbler 50 may contribute to the vapor pressure of the precursor. A vapor-phase precursor is introduced into the chamber 10 through a precursor-introducing line 54. The precursor-introducing line 54 is enclosed by a second heater 56. The second heater 56 may prevent the vapor-phase precursor from condensing while introducing the vapor-phase precursor into the chamber 10.

FIG. 3 presents a cross-sectional view illustrating a precursor introducer 16 having an injector type in accordance with some embodiments of the present invention. Referring to FIG. 3, a source 60 in the precursor introducer 16 having the injector includes a liquid-phase precursor. The liquid-phase precursor is transferred by pressure from the source 60 to an injector 62. Thus, the source 60 may not be further heated.

The injector 62 is connected to a vaporizer 64 maintained at a relatively high temperature. According to some embodiments of the present invention, a heater 66 is disposed inside the vaporizer 64. In some embodiments of the present invention, the heater 66 may be disposed on an inner top portion, an inner bottom portion or an outside wall of the vaporizer 64.

In some embodiments of the present invention, the vaporizer 64 may be disposed inside the chamber 10. The injector 62 may provide the liquid-phase precursor to the vaporizer 64 for a relatively short time. For example, the injector 62 may provide the liquid-phase precursor to the vaporizer 64 by a pulsing method for a period of time in a range from about 10 milliseconds to about 10 seconds. The liquid-phase precursor may be vaporized by the vaporizer 64, and then a vapor-phase precursor may be introduced into the chamber 10.

FIG. 4 presents a cross-sectional view illustrating a precursor introducer 16 having a liquid delivery system (LDS) in accordance with some embodiments of the present invention. Referring to FIG. 4, a source 70 in the precursor introducer 16 of the LDS type includes a liquid precursor. The source 70 may be maintained at room temperature or a lower temperature. A portion of the liquid-phase precursor in the source 70 is delivered to a vaporizer 72. A first heater 74 is disposed in an outside wall of the vaporizer 72. The first heater 74 heats the liquid-phase precursor in the vaporizer 72 to vaporize the liquid-phase precursor. A vapor-phase precursor is introduced into the chamber 10 through a precursor-introducing line 76. A second heater 78 is disposed in an outside wall of the precursor-introducing line 76. The precursor introducer 16 having the LDS type may prevent deterioration of the precursor, and may provide a constant amount of the precursor. Therefore, it may be desirable to employ the LDS type of precursor introducer 16 having into the chamber 10.

In some embodiments, the liquid-phase lanthanum precursor is vaporized in the precursor introducer 16 such as a bubbler, injector type or LDS type, followed by introduction of the vapor-phase lanthanum precursor 20 into the reaction space 11 of the chamber 10. A portion of the vapor-phase lanthanum precursor 20 is chemically adsorbed to the substrate 12 in the chamber 10. Referring to FIG. 1B, a first purge gas is introduced to remove a non-chemisorbed portion of the vapor-phase lanthanum precursor 20 from the chamber 10. The non-chemisorbed portion of the vapor-phase lanthanum precursor 20 may include a physisorbed portion of the vapor-phase lanthanum precursor 20.

The first purge gas may include an inactive gas, an inactive plasma or a mixture thereof. The first purge gas may include an argon (Ar) gas, a xenon (Xe) gas, a krypton (Kr) gas, a helium (He) gas, an argon plasma, a xenon plasma, a krypton plasma, a helium plasma and the like. The purge gas can be used alone or in combination, i.e., mixtures, with other suitable purge gases.

After removing the non-chemisorbed portion of vapor-phase lanthanum precursor 20 from the chamber 10 using the first purge gas, a single atomic layer 30 of the lanthanum precursor is formed on the substrate 12.

Referring to FIG. 1C, a reactant or a gas including the reactant is introduced into the reaction space 11 of the chamber 10. A type of lanthanum-including layer may be determined according to the type of reactants. More specifically, a lanthanum oxide layer, a lanthanum nitride layer and/or a lanthanum oxynitride layer may be formed by changing the type of reactant.

In some embodiments of the present invention, the reactant used for forming a lanthanum oxide layer includes an oxidizing agent 22. Examples of the oxidizing agent 22 may include oxygen (O₂), ozone (O₃), water vapor (H₂O) and the like, which can be used alone or in a mixture thereof. In some embodiments, the oxidizing agent 22 may exist in a plasma phase. The oxidizing agent 22 may be reacted with the single atomic layer 30 of a lanthanum precursor to form the lanthanum oxide.

Referring to FIG. 1D, a second purge gas is introduced into the chamber 10 to remove a non-reacted portion of the oxidizing agent 22 from the chamber 10. The second purge gas may include an inactive gas or an inactive plasma. As a result, a lanthanum oxide film 32 is formed on the substrate 12.

As shown in FIG. 1E, a lanthanum oxide layer 34 having a desired thickness is formed by repeatedly performing the steps of introducing a vapor-phase lanthanum precursor 20, introducing the first purge gas, providing the oxidizing agent 22 and introducing the second purge gas into the chamber 10.

In some embodiments of the present invention, a lanthanum-including layer may be formed at a temperature in a range of about 150° C. to about 600° C. under a pressure in a range of about 0.01 Torr to about 50 Torr. When the pressure of the chamber 10 is less than about 0.01 Torr and the temperature of the chamber 10 is less than about 150° C., a reaction for forming the lanthanum-including layer may not proceed as desired. When the pressure of the inside of the chamber 10 is greater than about 50 Torr and the temperature of the chamber 10 is greater than about 600° C., the step coverage of the lanthanum-including layer may deteriorate and byproducts may be generated. In some embodiments, the temperature of the chamber 10 is the same or substantially similar to the temperature of the substrate 12.

FIGS. 5A and 5B present cross-sectional views illustrating methods of forming a layer in accordance with some embodiments of the present invention. In FIGS. 5A and 5B, a lanthanum oxide layer is formed using a chemical vapor deposition process. Referring to FIG. 5A, after a substrate 12 is loaded in a chamber 10, a vapor-phase lanthanum precursor 20 and an oxidizing agent 22 are introduced into a reaction space 11 of the chamber 10.

A liquid-phase lanthanum precursor is vaporized by the precursor introducer 16 to form a vapor-phase lanthanum precursor 20. A vapor-phase lanthanum precursor 20 is introduced into the chamber 10 by a precursor introducer 16 such as a bubbler, an injector or a liquid delivery system (LDS) type as described above. The precursor introducer 16 of the LDS type may be desirable because deterioration of the precursor may be reduced or prevented and a constant amount of the precursor may be provided into the chamber 10.

A vapor-phase lanthanum precursor 20 is introduced into the reaction space 11 of the chamber 10, and simultaneously the oxidizing agent 22 is introduced into the reaction space 11 of the chamber 10. The oxidizing agent 22 may be the same or substantially similar to the oxidizing agent described with reference to FIG. 1C. A vapor-phase lanthanum precursor 20 may be reacted with the oxidizing agent 22 to form a lanthanum oxide on the substrate 12. As the lanthanum oxide is accumulatively deposited onto the substrate 12, a lanthanum oxide layer 40 having a desired thickness is formed on the substrate 12.

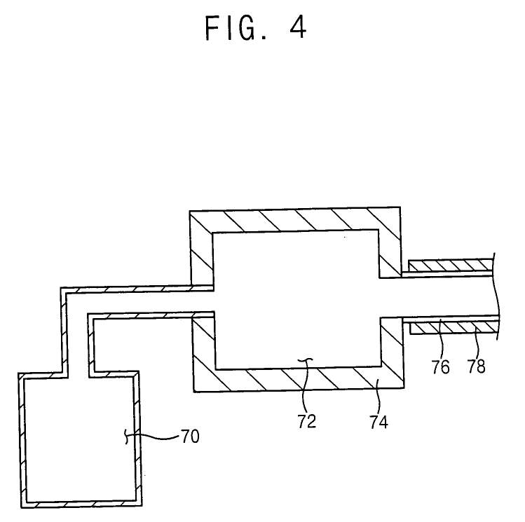

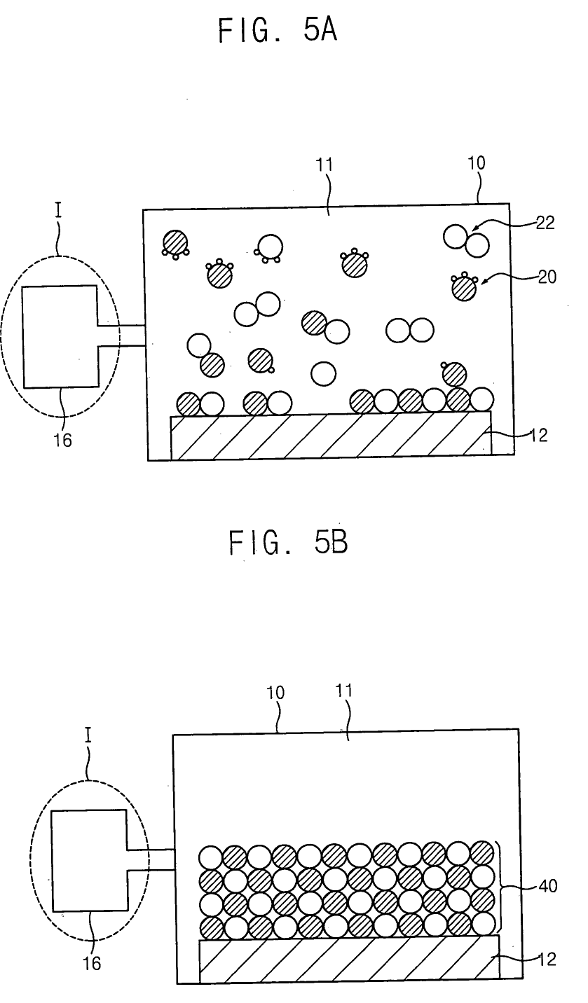

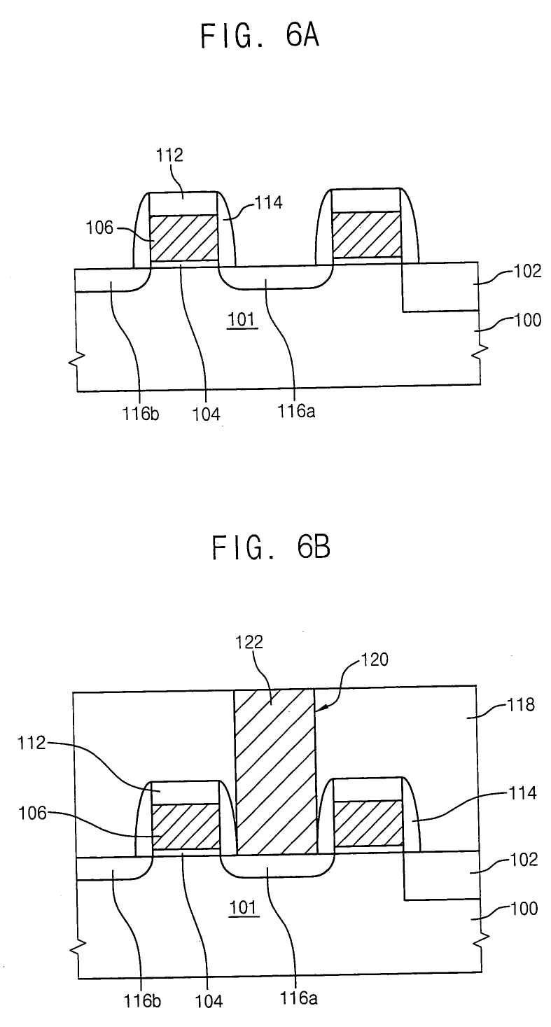

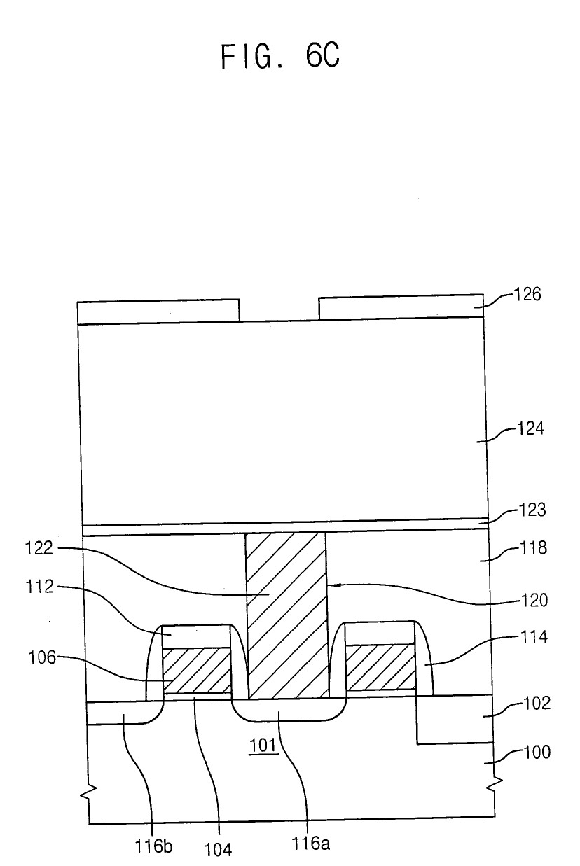

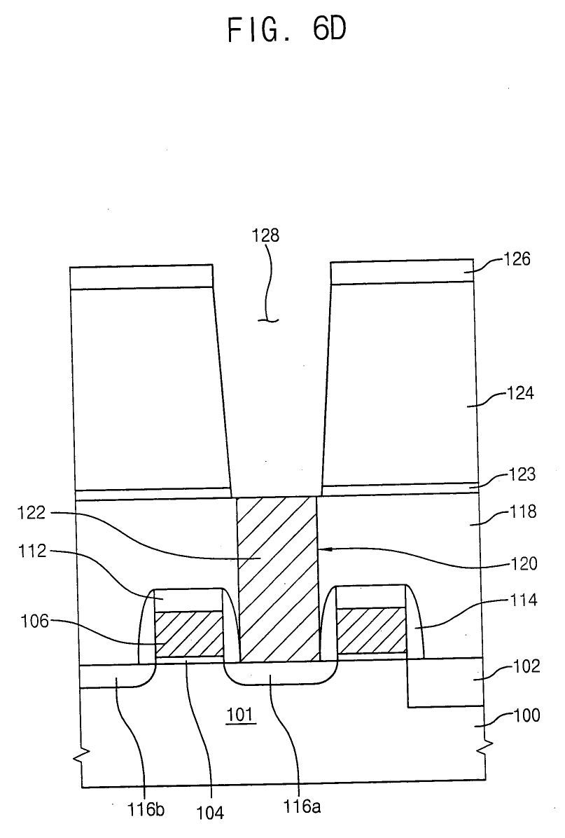

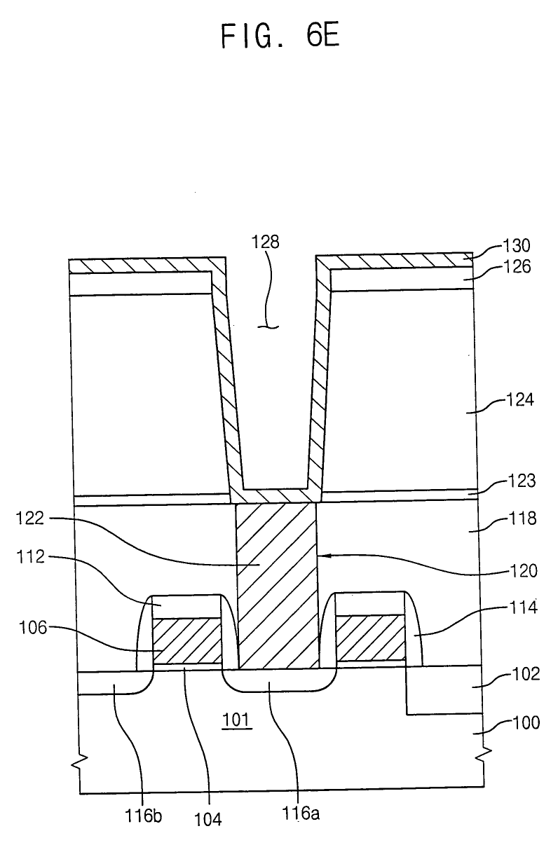

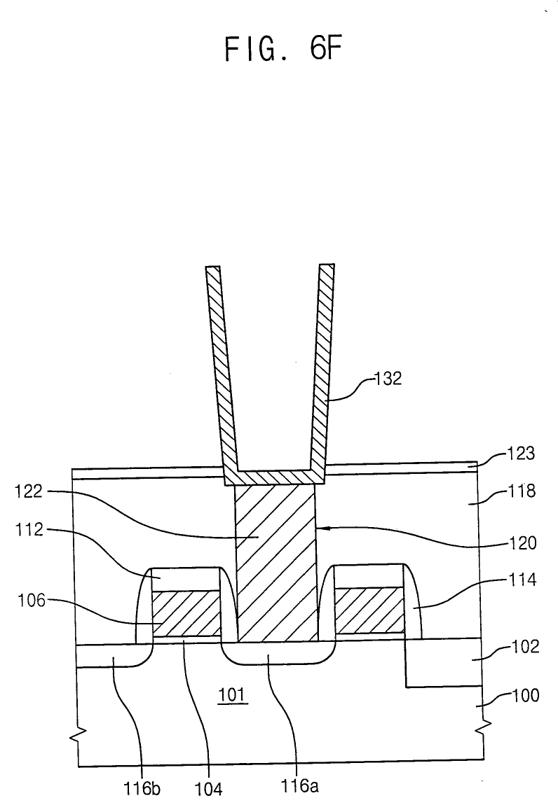

In some embodiments, the present invention provides methods of manufacturing a capacitor. Referring to FIG. 6A, an isolation layer 102 is formed on a semiconductor substrate 100 using an isolation process such as a shallow trench isolation (STI) process, a thermal oxidation process, a process employing local oxidation of silicon (LOCOS) and the like. An active region 101 and a field region may be defined on the semiconductor substrate 100 when the isolation layer 102 is formed on the semiconductor substrate 100.

A thin gate oxide layer is formed on the semiconductor substrate 100 including the isolation layer 102 using a thermal oxidation process or a chemical vapor deposition process. The thin gate oxide layer is formed on the active region 101 of the semiconductor substrate 100. The gate oxide layer may be patterned to form a gate oxide layer pattern 104 on the active region 101 of the semiconductor substrate 100.

In some embodiments, a first conductive layer is formed on the gate oxide layer and a first mask layer is formed on the first conductive layer. The first conductive layer and the first mask layer correspond to a gate conductive layer and a gate mask layer, respectively. In some embodiments of the present invention, the first conductive layer may include doped polysilicon. The first conductive layer may be patterned to form a gate conductive layer pattern 106 on the gate oxide layer pattern 104. In some embodiments of the present invention, the first conductive layer may have a polycide structure that includes a doped polysilicon film and a metal silicide film formed on the doped polysilicon film. The first mask layer may be patterned to form a gate mask 112 on the gate conductive layer pattern 106. The first mask layer is formed using a material that has an etching selectivity relative to an insulating interlayer 118 successively formed on the gate mask 112. For example, when the insulating interlayer 118 includes silicon oxide, the first mask layer may include silicon nitride.

In some embodiments, after a first photoresist pattern is formed on the first mask layer, the first mask layer, the first conductive layer and the gate oxide layer are sequentially etched using the first photoresist pattern as an etching mask to form gate structures on the semiconductor substrate 100. Each of the gate structures may include the gate oxide layer pattern 104, the gate conductive layer pattern 106 and the gate mask 112. In particular, the first mask layer, the first conductive layer and the gate oxide layer may be partially etched using the first photoresist pattern as the etching mask to form the gate structures on the semiconductor substrate 100. The first photoresist pattern on the gate mask 112 may be removed using an ashing process and/or a strip process.

In some embodiments, an insulation layer may be formed on the semiconductor substrate 100 to cover the gate structures. The insulation layer may be formed using nitride such as silicon nitride. The insulation layer may be anisotropically etched to form gate spacers 114 on the sidewalls of the gate structures. In some embodiments, impurities may be implanted into portions of the semiconductor substrate 100 exposed between the gate structures by using an ion implantation process. The gate structures including the gate spacers 114 may be employed as ion implantation masks in the ion implantation process.

After the ion implantation process, a thermal process may be employed to form contact regions 116a and 116b on the semiconductor substrate 100. The contact regions 116a and 116b correspond to source/drain regions. As a result, a metal oxide semiconductor (MOS) transistor structure may be formed on the semiconductor substrate 100.

Adjacent gate structures formed on the active region 101 of the semiconductor substrate 100 are electrically isolated from each other by the gate spacers 114 formed on the sidewalls of the gate structures. Referring to FIG. 6B, the insulating interlayer 118 is formed on the semiconductor substrate 100 to cover the gate structures. The insulation interlayer may include an oxide. For example, the insulating interlayer 118 may include boro-phosphor silicate glass (BPSG), phosphor silicate glass (PSG), undoped silicate glass (USG), spin on glass (SOG), plasma enhanced-tetraethylorthosilicate (PE-TEOS), high density plasma-chemical vapor deposition (HDP-CVD) oxide and the like.

The insulating interlayer 118 may be planarized using a chemical mechanical polishing (CMP) process, an etch-back process or a combination process of CMP and etch back.

In some embodiments, after a second photoresist pattern is formed on the insulating interlayer 118, the insulating interlayer 118 may be partially etched by a dry etching process using the second photoresist pattern as an etching mask to thereby form a first contact hole 120 through the insulating interlayer 118. The first contact hole 120 exposes the contact region 116a on the semiconductor substrate 100. For example, when the insulating interlayer 118 includes oxide, the insulating interlayer 118 may be etched using an etching gas having a high etching selectivity relative to the gate mask 112 including nitride.

After removing the second photoresist pattern using an ashing process and/or a strip process, a second conductive layer may be formed on the insulating interlayer 118 to fill up the first contact hole 120. For example, the second conductive layer may be formed using a conductive material such as doped polysilicon, a conductive metal nitride or a metal. For example, the second conductive layer may be formed using titanium nitride, aluminum nitride, titanium aluminum nitride, tungsten, aluminum, titanium, copper and the like.

The second conductive layer may be partially removed using a CMP process, an etch-back process or a combination process of CMP and etch back process until insulating interlayer 118 is exposed. Thus, a contact pad 122 filling the first contact hole 120 may be formed on the contact region 116a. Referring to FIG. 6C, an etching stop layer 123 is formed on the insulating interlayer 118 including the contact pad 122. The etching stop layer 123 may include a material that has an etching selectivity relative to that of the insulating interlayer 118 and that of a mold layer 124 successively formed on the etching stop layer 123. For example, when the insulation interlayer 118 and the mold layer 124 include oxide, the etching stop layer 123 may include a nitride such as silicon nitride. The mold layer 124 is formed on the etching stop layer 123. The mold layer 124 is provided to form a lower electrode 132 (see FIG. 6F). For example, the mold layer 124 may be formed using an oxide such as BPSG, PSG, USG, PE-TEOS, SOG, HDP-CVD oxide and the like. A thickness of the mold layer 124 may be controlled in accordance with a desired capacitance of the capacitor. An aspect ratio of the capacitor may be determined by the thickness of the mold layer 124, and thus, the thickness of the mold layer 124 may be adjusted to obtain the desired capacitance of the capacitor.

In some embodiments, a second mask layer is formed on the mold layer 124. The second mask layer may include a material having a high etching selectivity relative to that of the mold layer 124. For example, when the mold layer 124 includes oxide, the second mask layer may include polysilicon or silicon nitride. After a third photoresist pattern is formed on the second mask layer, the second mask layer is etched using the third photoresist pattern as an etching mask to form a storage node mask 126 on the mold layer 124. Referring to FIG. 6D, after the third photoresist pattern is removed by an ashing process and/or a strip process, the mold layer 124 and the etching stop layer 123 are sequentially etched using the storage node mask 126 as an etching mask to form a second contact hole 128. The second contact hole 128 corresponds to a storage contact hole. In some embodiments of the present invention, a native oxide layer or particles may be removed from the semiconductor substrate 100 including the second contact hole 128 by a cleaning process. The cleaning process may be performed using a cleaning solution for a period of time in a range from about 5 minutes to about 20 minutes. For example, the cleaning solution may include deionized water, an ammonia aqueous solution or a solution including sulfuric acid. The mold layer 124 may be partially etched in the cleaning process so that a dimension of the second contact hole 128 may be enlarged.

Referring to FIG. 6E, a third conductive layer 130 is formed on a sidewall and a bottom of the second contact hole 128, and the storage node mask 126. The third conductive layer 130 may include a conductive material such as doped polysilicon, metal, conductive metal nitride, etc. Referring to FIG. 6F, a portion of the third conductive layer 130 formed on the storage node mask 126 and the mold layer 124 may be removed, whereas the third conductive layer 130 may remain on the sidewall and the bottom of the second contact hole 128. Hence, the lower electrode 132 may be formed on the sidewall and the bottom of the second contact hole 128. In order to enhance an effective area of the lower electrode 132, the lower electrode 132 has a three-dimensional structure. For example, the lower electrode 132 may be a suitable structure including a box structure, a cylindrical structure, a stacked structure, a trench structure and the like. In some embodiments of the present invention, the lower electrode 132 has the cylindrical structure as shown in FIGS. 6D to 61.

In some embodiments of the present invention, the semiconductor substrate 100 including the lower electrode 132 may be selectively cleaned using a cleaning solution such as a hydrogen fluoride solution, a sulfuric acid solution or a standard cleaning solution (SC-1) including ammonia and hydrogen peroxide. When the lower electrode 132 includes titanium nitride, cleaning the surface of the lower electrode 132 may improve interfacial characteristics between the lower electrode 132 and a dielectric layer 136 (see FIG. 6H) successively formed on the lower electrode 132.

Referring to FIGS. 6G and 6H, after cleaning the semiconductor substrate 100 including the lower electrode 132, a pre-treatment layer 134 may be selectively formed on the semiconductor substrate 100 including the lower electrode 132 by using a pretreatment process. The pre-treatment layer 134 may prevent a reaction between the lower electrode 132 and the dielectric layer 136. Additionally, the pre-treatment layer 134 may prevent diffusion of ingredients between the dielectric layer 136 and the lower electrode 132. Thus, the pre-treatment layer 134 may prevent deterioration of the dielectric layer 136. The pre-treatment layer 134 may disperse an electric field directly applied to the dielectric layer 136 during operation of a semiconductor device. Thus, leakage current from the dielectric layer 136 may be reduced or prevented. When the lower electrode 132 includes silicon, the pre-treatment layer 134 may be more readily formed on the lower electrode layer 132. For example, the pre-treatment layer 134 may be formed using a pre-treatment process such as a rapid thermal process (RTP), a chemical vapor deposition (CVD) process, an atomic layer deposition (ALD) process and the like.

The RTP may include a rapid thermal nitridation (RTN) process, a rapid thermal oxidation (RTO) process or a combination process of RTN and RTO. The RTN process may be performed using a nitriding agent such as ammonia (NH₃), nitrogen (N₂) and the like. The nitriding agent can be used alone or in a mixture thereof. The RTO process may be performed using an oxidizing agent such as oxygen (O₂), nitrous oxide (N₂O) and the like. The oxidizing agent can be used alone or in a mixture thereof. In some embodiments of the present invention, the nitriding agent and the oxidizing agent may have a plasma phase or may be activated by ultraviolet (UV) radiation in order to lower the activation energy in the RTN process and/or RTO process. In some embodiments of the present invention, the RTN process and/or the RTO process may be performed in a temperature in a range of about 500° C. to about 900° C. When the temperature of the chamber in which the substrate 100 is loaded is less than about 500° C. in the RTN process and/or the RTO process, the oxidizing agent or the nitriding agent may not react properly with the lower electrode 132. When the temperature of the chamber is greater than about 900° C. in the RTN process and/or the RTO process, byproducts may be generated. The temperature of the chamber is the same or substantially similar to the temperature of the semiconductor substrate.

Instead of an RTP, the pre-treatment layer 134 may be formed using a CVD process or an ALD process. The pre-treatment layer 134 may include silicon oxide, silicon nitride or silicon oxynitride. The pre-treatment layer 134 may have a decreased thickness. The pre-treatment layer 134 may prevent the reaction between the lower electrode 132 and the dielectric layer 136. The pre-treatment layer 134 may prevent diffusion of material between the dielectric layer 136 and the lower electrode 132. Thus, the pre-treatment layer 134 may prevent deterioration of the dielectric layer 136. Additionally, the pre-treatment layer 134 may disperse an electric field directly applied to the dielectric layer 136 in the operation of the semiconductor device. Thus, leakage current from the dielectric layer 136 may be reduced.

In some embodiments of the present invention, the pre-treatment layer 134 may be formed on the lower electrode 132 before the formation of the dielectric layer 136. In some embodiments of the present invention, the pre-treatment layer 134 may be formed on the lower electrode 132 simultaneously with the dielectric layer 136. The pre-treatment layer 134 may be selectively formed on the semiconductor substrate 100 including the lower electrode 132. In some embodiments of the present invention, the dielectric layer 136 may be directly formed on the lower electrode 132. In some embodiments of the present invention, the dielectric layer 136 may be formed on the pre-treatment layer 134.

Referring to FIG. 6H, the dielectric layer 136 is formed on the pre-treatment layer 134. The dielectric layer 136 may be formed using a deposition process such as a CVD process, a physical vapor deposition (PVD) process, an ALD process and the like. The CVD process or the ALD process may be more readily employed for forming the dielectric layer 136 on the lower electrode 132 having a complicated three-dimensional structure because the dielectric layer 136 formed through the CVD process or the ALD process may have an enhanced step-coverage.

In some embodiments of the present invention, the dielectric layer 136 may include lanthanum oxide formed using a lanthanum precursor. A liquid-phase lanthanum precursor may be vaporized into a vapor-phase lanthanum precursor. The dielectric layer 136 including lanthanum oxide may be formed using a vapor-phase lanthanum precursor. The dielectric layer 136 may be formed by a process substantially similar to the process described with reference to FIGS. 1A to 5B.

The dielectric layer 136 may be thermally treated to prevent generation of a leakage current from the dielectric layer 136. When the dielectric layer 136 is not thermally treated, the dielectric layer 136 may have a coarse structure so that a leakage current may be generated from the dielectric layer 136. The thermal treatment process for the dielectric layer 136 may be performed under a suitable atmosphere including, but not limited to, oxygen gas, an ozone gas, a nitrous oxide gas, an argon gas, a nitrogen gas, a hydrogen gas, a helium gas, an ammonia gas, an oxygen plasma, an ozone plasma, a nitrous plasma, an argon plasma, a nitrogen plasma, a hydrogen plasma, a helium plasma, an ammonia plasma, an oxygen activated by ultraviolet radiation, an ozone activated by ultraviolet radiation, a nitrous oxide activated by ultraviolet radiation, an argon activated by ultraviolet radiation, a nitrogen activated by ultraviolet radiation, a hydrogen activated by ultraviolet radiation, a helium activated by ultraviolet radiation, an ammonia activated by ultraviolet radiation and the like, alone or in mixtures thereof.

The thermal treatment process for the dielectric layer 136 may be performed at a temperature in a range of about 200° C. to about 800° C. under a pressure in a range of about 0.1 to about 760 Torr. When the pressure of the chamber where the semiconductor substrate 100 is loaded is less than about 0.1 Torr and a temperature of the semiconductor substrate 100 in the chamber is less than about 200° C., the dielectric layer 136 may not be properly treated under the atmosphere. When the pressure of the chamber is greater than about 760 Torr and the temperature on the semiconductor substrate 100 in the chamber is greater than about 800° C., byproducts may be generated and materials included in the dielectric layer 136 may diffuse into the lower electrode 132.

In some embodiments of the present invention, the dielectric layer 136 may be formed by alternately repeating the steps of the deposition process and the thermal treatment process so that the dielectric layer 136 may have a desired thickness. Thus, the dielectric layer 136 may exhibit improved electrical characteristics.

Referring to FIG. 61, an upper electrode 138 is formed on the dielectric layer 136. The upper electrode 138 may be formed using a conductive material such as doped polysilicon, metal, conductive metal nitride and the like.

In some embodiments of the present invention, the capacitor includes the lower electrode 132, the pre-treatment layer 134, the dielectric layer 136 and the upper electrode 138 as illustrated in FIG. 61. In some embodiments of the present invention, the capacitor may include the lower electrode 132, the dielectric layer 136 and the upper electrode 138 without the pre-treatment layer 134.

An additional insulation layer may be formed on the upper electrode 138 to electrically insulate the upper electrode 138 from an upper conductive wiring successively formed on the additional insulation layer.

Methods of manufacturing a capacitor will be further described through examples and comparative examples provided below.

### EXAMPLE 1

A capacitor including a lanthanum oxide layer as a dielectric layer was manufactured over a substrate. A lower electrode of the capacitor was formed using a polysilicon doped with impurities. A pre-treatment layer of the capacitor was formed on the lower electrode by an RTN process. The RTN process was performed under an ammonia atmosphere. The pre-treatment layer was formed using silicon oxynitiride. A lanthanum oxide layer was formed on the lower electrode using an ALD process. In the ALD process, the lanthanum oxide layer was formed by performing at least one cycle that included introducing La(iPrCp)₃ into a chamber, purging the chamber, introducing an oxidizing agent into the chamber and subsequently purging the chamber. La(iPrCp)₃ was introduced into the chamber using an injector type precursor introducer. A vaporizer was maintained at a temperature of about 220° C., and a stage heater upon which a semiconductor substrate was loaded, was maintained at a temperature of about 350° C. The lanthanum oxide layer was used as a dielectric layer of the capacitor.

An upper electrode was formed on the lanthanum oxide layer using titanium nitride. The upper electrode layer had a thickness of about 1,000 Å measured from an upper face of the lanthanum oxide layer.

### EXAMPLE 2

A capacitor was manufactured by performing processes substantially similar to those described in Example 1, with the exception that the lanthanum oxide layer was subjected to a thermal treatment process performed at a temperature of about 600° C. under an atmosphere including nitrogen for about ten minutes between forming the lanthanum oxide layer and forming an upper electrode.

### COMPARATIVE EXAMPLE 1

A capacitor was manufactured by performing processes substantially similar to those described in Example 2, with the exception that an aluminum oxide layer was formed as a dielectric layer. The aluminum oxide layer was formed by repeating a cycle of an ALD process until the aluminum oxide layer had leakage current characteristics substantially similar to those of the lanthanum oxide layer according to Example 2.

### COMPARATIVE EXAMPLE 2

A capacitor was manufactured by performing processes substantially similar to those described in Example 2, with the exception that a hafnium oxide layer was formed as a dielectric layer. The hafnium oxide layer was formed by repeating a cycle of an ALD process until the hafnium oxide layer had leakage current characteristics substantially identical to those of the lanthanum oxide layer according to Example 2.

Evaluation of a Dielectric Constant of a Lanthanum Oxide Layer

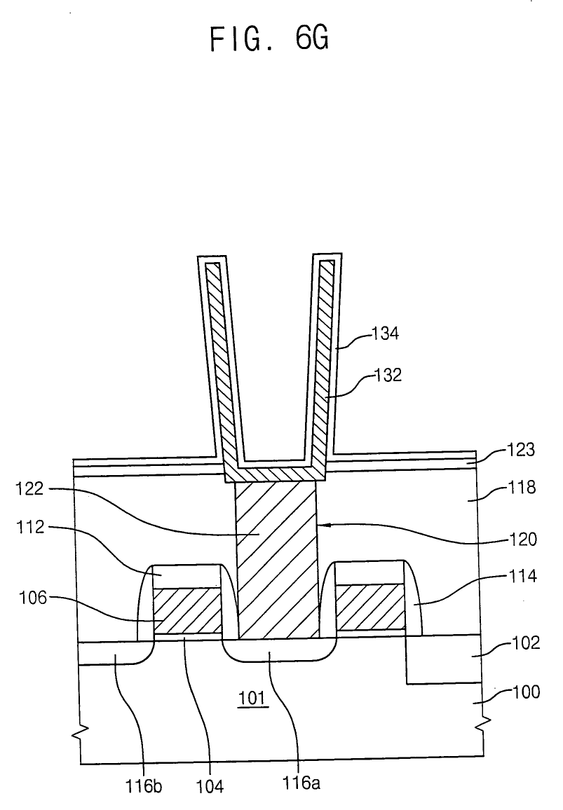

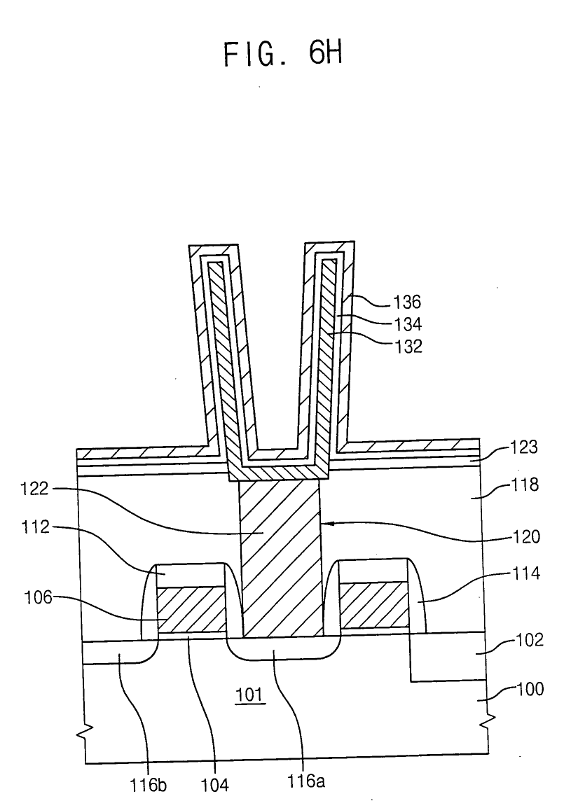

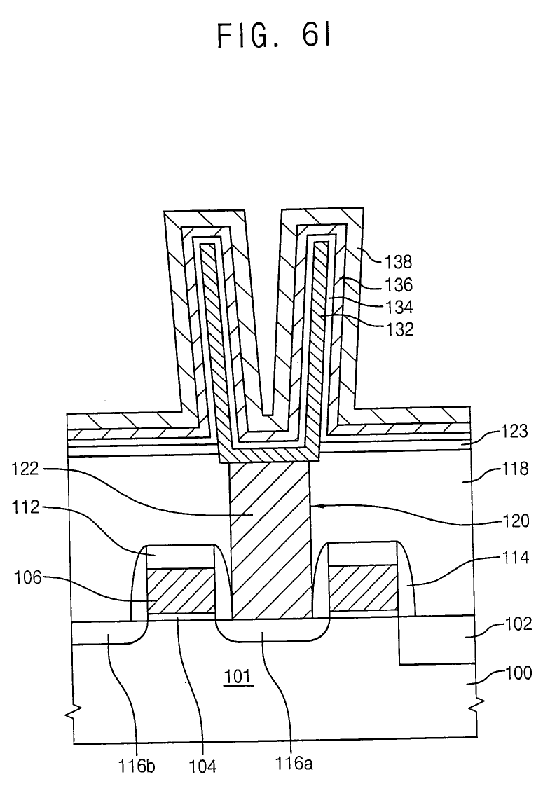

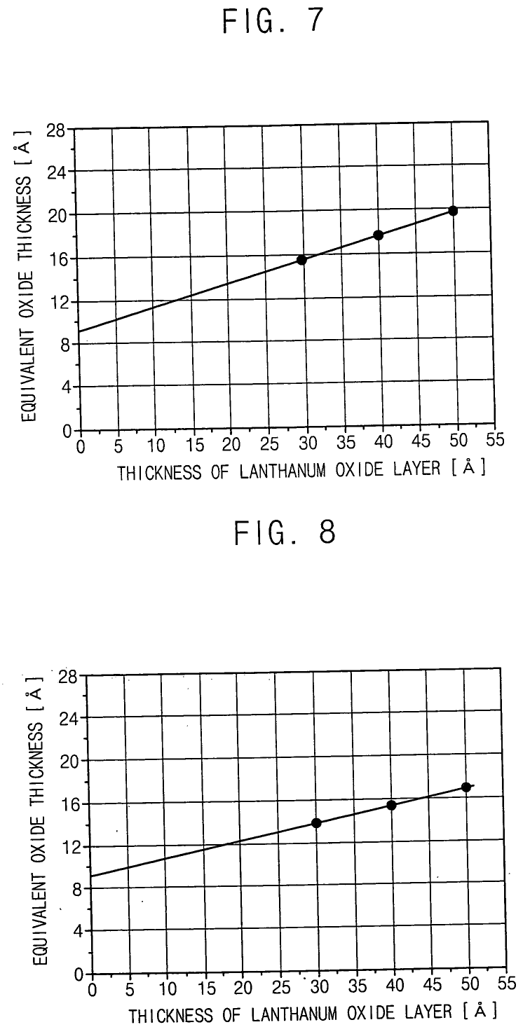

Dielectric constants of lanthanum oxide layers according to Examples 1 and 2 were evaluated as shown in FIGS. 7 and 8. FIGS. 7 and 8 present graphs illustrating dielectric constants of the lanthanum oxide layers in accordance with example embodiments of the present invention. FIG. 7 is a graph illustrating the dielectric constant of the lanthanum oxide layer of Example 1, and FIG. 8 is a graph illustrating the dielectric constant of the lanthanum oxide layer of Example 2.

Referring to FIG. 7, the dielectric constant of the lanthanum oxide layer of Example 1 was about 18.6.

Referring to FIG. 8, the dielectric constant of the lanthanum oxide layer of Example 2 was about 22.3. As understood by those skilled in the art, the dielectric constants were calculated from slopes of the graphs in FIGS. 7 and 8. The dielectric constants of the lanthanum oxide layers of Examples 1 and 2 were compared with dielectric constants of conventional dielectric layers as shown in the Table 2 below.

TABLE 2

| Type of Dielectric Layer | Dielectric Constant |
|---|---|
| Silicon Oxide Layer | About 3.9 |
| Silicon Nitride Layer | About 7.2 |
| Composite Layer of Silicon Nitride Layer and | About 3.9 to 7.2 |
| Silicon Oxide Layer | |
| Example 1 | About 18.6 |
| Example 2 | About 22.3 |

Referring to Table 2, the dielectric constants of some lanthanum oxide layers according to some embodiments of the present invention were higher than those of the dielectric constants of the conventional dielectric layers such as silicon oxide layers, silicon nitride layers, or composite layers thereof. Therefore, the capacitor including the lanthanum oxide layer invention may have a capacitance larger than that of the conventional capacitor including the conventional dielectric layer.

The dielectric layer of Example 2 had a higher dielectric constant compared with that of the dielectric layer of Example 1. As for Example 2, the thermal treatment process between forming the dielectric layer and forming the upper electrode was performed only for the dielectric layer. Therefore, the thermal treatment process after formation of the lanthanum oxide layer may enhance the capacitance of the capacitor.

Evaluation of a Leakage Current Relative to Types of Dielectric Layers

Leakage current characteristics were evaluated with respect to the dielectric layers according to Example 2, Comparative Example 1 and Comparative Example 2.

As noted above in the evaluation of the dielectric constants of the lanthanum oxide layers, the lanthanum oxide layers have high dielectric constants compared with those of the conventional dielectric layers such as a silicon oxide layer, a silicon nitride layer or a composite layer of a silicon oxide layer and a silicon nitride layer. The lanthanum oxide layer, an aluminum oxide layer and a hafnium oxide layer may be generally used as a dielectric layer having a high dielectric constant. Leakage current characteristics were evaluated after manufacturing the capacitors including the dielectric layers having the high dielectric constants according to Example 2 and Comparative Examples 1 and 2.

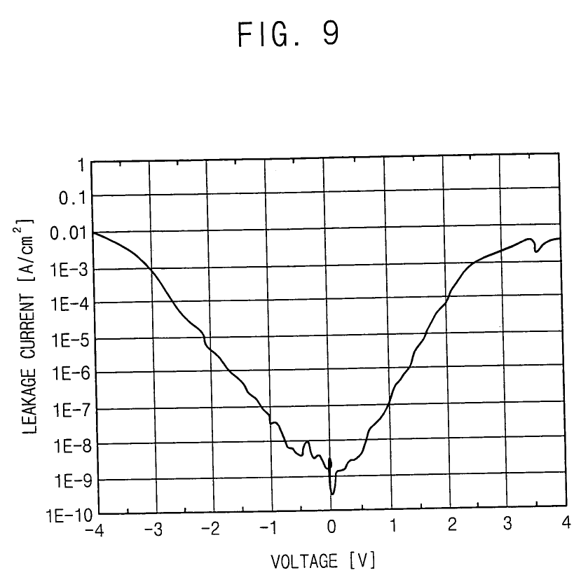

FIG. 9 presents a graph illustrating leakage current characteristics of the dielectric layer according to Example 2. Referring to FIG. 9, when a voltage of about 1V was applied to the lanthanum oxide layer of Example 1, a leakage current of about 1×10⁻⁷ A/cm² was generated from the lanthanum oxide layer having a thickness of about 17.2 Å. When a voltage of about 1V was applied to the aluminum oxide layer of Comparative Example 1, a leakage current of about 1×10⁻⁷ A/cm² was generated from the aluminum oxide layer having a thickness of about 31 Å. When a voltage of about 1V was applied to the hafnium oxide layer of Comparative Example 2, a leakage current of about 1×10⁻⁷ A/cm² was generated from the hafnium oxide layer having a thickness of about 23 Å as shown in Table 3 presented below.

TABLE 3

| | Type of Dielectric Layer | Thickness [Å] |
|---|---|---|
| Example 2 | Lanthanum Oxide Layer | About 17.2 |
| Comparative Example 1 | Aluminum Oxide Layer | About 31 |
| Comparative Example 2 | Hafnium Oxide Layer | About 23 |

As the thickness of a dielectric layer is reduced, leakage current may be more readily generated from the dielectric layer, whereas a capacitor has a larger capacitance. Therefore, the capacitor may have a dielectric layer that has a reduced thickness and/or enhanced leakage current characteristics.

Referring to Table 3, when a voltage of about 1V was applied to the dielectric layers, the thin lanthanum oxide layer of Example 2 had a leakage current substantially similar to the thicker aluminum oxide layer and the thicker hafnium oxide layer of Comparative Examples 1 and 2. Therefore, the thin lanthanum oxide layer formed using La(iPrCp)₃ may have enhanced leakage current characteristics compared with those of the thicker aluminum oxide layer and the thicker hafnium oxide layer. Consequently, the thin lanthanum oxide layer of the present invention may have a high dielectric constant and/or enhanced leakage current characteristics.

According to the present invention, a lanthanum-including layer employed as a dielectric layer may be formed using a liquid-phase precursor such as La(iPrCp)₃. Thus, problems associated with a solid-phase precursor may be reduced or prevented. In particular, a coarse dielectric layer generated by diffusion of impurities such as carbon may be reduced or prevented, and deterioration of the dielectric layer generated by migration of carbon may be reduced or prevented. Accordingly, a semiconductor device including the dielectric layer may have enhanced electrical characteristics, and insufficiencies of the semiconductor device may be reduced or prevented.

The foregoing is illustrative of the present invention and is not to be construed as limiting thereof. Although some embodiments of this invention have been described, one of ordinary skill in the art will readily appreciate that modifications to the embodiments are possible without departing from the teachings of the invention. Accordingly, all such modifications are intended to be included within the scope of this invention as defined in the claims, with equivalents of the claims to be included therein.

What is claimed is:

1. A method of forming a layer comprising:
forming a layer comprising lanthanum using a lanthanum precursor having a liquid-phase at a room temperature.

2. The method of claim 1, wherein the lanthanum precursor comprises tris(i-propylcyclopentadienyl)lanthanum (La(iPrCp)₃).

3. The method of claim 1, wherein the layer comprising lanthanum comprises a lanthanum oxide layer, a lanthanum nitride layer or a lanthanum oxynitride layer.

4. The method of claim 1, wherein the layer comprising lanthanum is formed at a temperature in a range of about 150° C. to about 600° C.

5. The method of claim 1, wherein the layer comprising lanthanum is formed under a pressure in a range of about 0.01 Torr to about 50 Torr.

6. A method of forming a layer on a semiconductor substrate comprising:
forming a thin layer comprising lanthanum using La(iPrCp)₃ as a lanthanum precursor.

7. A method of forming a layer on an object comprising:
introducing a vapor-phase La(iPrCp)₃ onto the object; and
forming a lanthanum oxide layer on the object using the vapor-phase La(iPrCp)₃.

8. The method of claim 7, wherein the vapor-phase La(iPrCp)₃ is formed by vaporizing a liquid-phase La(iPrCp)₃ using a precursor introducer comprising a bubbler, an injector or a liquid delivery system (LDS).

9. The method of claim 7, wherein the lanthanum oxide layer is formed using an atomic layer deposition process or a chemical vapor deposition process.

10. The method of claim 9, wherein forming the lanthanum oxide layer using the atomic layer deposition process comprises:
chemisorbing a portion of the vapor-phase La(iPrCp)₃ on the object after introducing the vapor-phase La(iPrCp)₃ onto the object;
removing a non-chemisorbed portion of the vapor-phase La(iPrCp)₃ from the object by introducing a first purge gas onto the object;
introducing an oxidizing agent onto the object;
reacting a portion of the oxidizing agent with the chemisorbed portion of the vapor-phase La(iPrCp)₃ to form the lanthanum oxide layer on the object; and
removing a non-reacted portion of the oxidizing agent from an ambient of the object by introducing a second purge gas onto the object.

11. The method of claim 10, wherein the oxidizing agent comprises oxygen, ozone, water vapor or a combination thereof.

12. The method of claim 11, wherein the oxidizing agent comprises a plasma phase.

13. The method of claim 10, wherein the first purge gas and the second purge gas independently comprise an inactive gas or an inactive plasma.

14. The method of claim 10, wherein the first purge gas and the second purge gas independently comprise argon, xenon, krypton, helium, argon plasma, xenon plasma, krypton plasma, helium plasma or a combination thereof.

15. The method of claim 10, wherein the steps of the method are performed at least once, independently or in combination.

16. The method of claim 9, wherein forming the lanthanum oxide layer using the chemical vapor deposition process comprises:
introducing the vapor-phase La(iPrCp)₃ and an oxidizing agent onto the object; and
reacting the vapor-phase La(iPrCp)₃ with the oxidizing agent to form the lanthanum oxide layer on the object.

17. A method of manufacturing a capacitor comprising:
forming a lower electrode on a substrate comprising lower structures;
forming a lanthanum oxide layer on the lower electrode using a lanthanum precursor having a liquid phase at room temperature; and
forming an upper electrode on the lanthanum oxide layer.

18. The method of claim 17, wherein the lower electrode and the upper electrode independently comprise doped polysilicon, a metal or a conductive metal nitride.

19. The method of claim 17, wherein the method further comprises cleaning the substrate using a cleaning solution after forming the lower electrode on the substrate.

20. The method of claim 19, wherein the cleaning solution comprises a solution comprising hydrogen fluoride, sulfuric acid, or ammonia and hydrogen peroxide.

21. The method of claim 19, wherein the method further comprises forming a pre-treatment layer on the lower electrode after cleaning the substrate.

22. The method of claim 21, wherein the pre-treatment layer: is formed using a rapid thermal process, a chemical vapor deposition process or an atomic layer deposition process.

23. The method of claim 22, wherein the rapid thermal process is performed under an atmosphere comprising nitrogen gas, ammonia gas, oxygen gas, nitrous oxide gas, nitrogen plasma, ammonia plasma, oxygen plasma, nitrous oxide plasma, nitrogen activated by ultraviolet radiation, ammonia activated by ultraviolet radiation, oxygen activated by ultraviolet radiation, nitrous oxide activated by ultraviolet radiation and combinations thereof.

24. The method of claim 22, wherein the rapid thermal process is performed at a temperature in a range of about 500° C. to about 900° C.

25. The method of claim 21, wherein the pre-treatment layer comprises silicon oxide, silicon nitride or silicon oxynitride.

26. The method of claim 17, wherein the method comprises thermally treating the lanthanum oxide layer.

27. The method of claim 26, wherein forming the lanthanum oxide layer and thermally treating the lanthanum oxide layer are performed at least once prior to forming the upper electrode on the lanthanum oxide layer.

28. The method of claim 26, wherein thermally treating the lanthanum oxide layer is performed at a temperature in a range of about 200° C. to about 800° C.

29. The method of claim 26, wherein thermally treating the lanthanum oxide layer is performed under a pressure in a range of about 0.1 Torr to about 760 Torr.

30. The method of claim 26, wherein thermally treating the lanthanum oxide layer is performed under an atmosphere comprising oxygen gas, ozone gas, nitrous oxide gas, argon gas, nitrogen gas, hydrogen gas, helium gas, ammonia gas, oxygen plasma, ozone plasma, nitrous plasma, argon plasma, nitrogen plasma, hydrogen plasma, helium plasma, ammonia plasma, oxygen activated by ultraviolet radiation, ozone activated by ultraviolet radiation, nitrous oxide activated by ultraviolet radiation, argon activated by ultraviolet radiation, nitrogen activated by ultraviolet radiation, hydrogen activated by ultraviolet radiation, helium activated by ultraviolet radiation, ammonia activated by ultraviolet radiation and combinations thereof.
